(19) United States
(12) Patent Application Publication
(10) Pub. No.: US 2024/0155719 A1
(43) Pub. Date: May 9, 2024

(54) UPLINK CHANNEL TRANSMISSIONS USING PER-TRANSMIT-RECEIVE-POINT-AND-PANEL POWER CONTROL PARAMETERS

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US); Tao LUO, San Diego, CA (US)

(21) Appl. No.: 18/549,472

(22) PCT Filed: May 18, 2021
(86) PCT No.: PCT/CN21/94317

§ 371 Date: Sep. 7, 2023

(51) Int. Cl. H04W 76/19; H04W 52/08; H04W 52/14; H04W 72/1273

(52) U.S. Cl. CPC H04W 76/19; H04W 52/08; H04W 52/146; H04W 72/1273

(57) ABSTRACT

Various aspects of the present disclosure generally relate to wireless communication. In some aspects, a user equipment (UE) may transmit, to a base station, a beam failure recovery request based at least in part on a beam failure between a transmit-receive point (TRP) of the base station and a panel of the UE. The UE may receive, from the base station, a beam failure recovery response based at least in part on the beam failure recovery request. The UE may perform, to the base station, an uplink channel transmission based at least in part on per-TRP-and-panel power control parameters that are associated with the TRP and the panel. Numerous other aspects are described.

### FIELD OF THE DISCLOSURE

Aspects of the present disclosure generally relate to wireless communication and to techniques and apparatuses for uplink channel transmissions using per-transmit-receive-point (TRP)-and-panel power control parameters.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BS s) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a TRP, a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a UE for wireless communication includes a memory and one or more processors, coupled to the memory, configured to: transmit, to a base station, a beam failure recovery request based at least in part on a beam failure between a TRP of the base station and a panel of the UE; receive, from the base station, a beam failure recovery response based at least in part on the beam failure recovery request; and perform, to the base station, an uplink channel transmission based at least in part on per-TRP-and-panel power control parameters that are associated with the TRP and the panel.

In some aspects, a base station for wireless communication includes a memory and one or more processors, coupled to the memory, configured to: receive, from a UE, a beam failure recovery request based at least in part on a beam failure between a TRP of the base station and a panel of the UE; transmit, to the UE, a beam failure recovery response based at least in part on the beam failure recovery request; and receive, from the UE, an uplink channel transmission based at least in part on per-TRP-and-panel power control parameters that are associated with the TRP and the panel.

In some aspects, a method of wireless communication performed by a UE includes transmitting, to a base station, a beam failure recovery request based at least in part on a beam failure between a TRP of the base station and a panel of the UE; receiving, from the base station, a beam failure recovery response based at least in part on the beam failure recovery request; and performing, to the base station, an uplink channel transmission based at least in part on per-TRP-and-panel power control parameters that are associated with the TRP and the panel.

In some aspects, a method of wireless communication performed by a base station includes receiving, from a UE, a beam failure recovery request based at least in part on a beam failure between a TRP of the base station and a panel of the UE; transmitting, to the UE, a beam failure recovery response based at least in part on the beam failure recovery request; and receiving, from the UE, an uplink channel transmission based at least in part on per-TRP-and-panel power control parameters that are associated with the TRP and the panel.

In some aspects, a non-transitory computer-readable medium storing a set of instructions for wireless communication includes one or more instructions that, when executed by one or more processors of a UE, cause the UE to: transmit, to a base station, a beam failure recovery request based at least in part on a beam failure between a TRP of the base station and a panel of the UE; receive, from the base station, a beam failure recovery response based at least in part on the beam failure recovery request; and perform, to the base station, an uplink channel transmission based at least in part on per-TRP-and-panel power control parameters that are associated with the TRP and the panel.

In some aspects, a non-transitory computer-readable medium storing a set of instructions for wireless communication includes one or more instructions that, when executed by one or more processors of a base station, cause the base station to: receive, from a UE, a beam failure recovery request based at least in part on a beam failure between a TRP of the base station and a panel of the UE; transmit, to the UE, a beam failure recovery response based at least in part on the beam failure recovery request; and receive, from the UE, an uplink channel transmission based at least in part on per-TRP-and-panel power control parameters that are associated with the TRP and the panel.

In some aspects, an apparatus for wireless communication includes means for transmitting, to a base station, a beam failure recovery request based at least in part on a beam failure between a TRP of the base station and a panel of the apparatus; means for receiving, from the base station, a beam failure recovery response based at least in part on the beam failure recovery request; and means for performing, to the base station, an uplink channel transmission based at least in part on per-TRP-and-panel power control parameters that are associated with the TRP and the panel.

In some aspects, an apparatus for wireless communication includes means for receiving, from a UE, a beam failure recovery request based at least in part on a beam failure between a TRP of the apparatus and a panel of the UE; means for transmitting, to the UE, a beam failure recovery response based at least in part on the beam failure recovery request; and means for receiving, from the UE, an uplink channel transmission based at least in part on per-TRP-and-panel power control parameters that are associated with the TRP and the panel.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example associated with downlink channel and uplink channel repetitions, in accordance with the present disclosure.

FIG. 4 is a diagram illustrating an example associated with uplink channel transmissions using per-TRP-and-panel power control parameters, in accordance with the present disclosure.

FIG. 5 is a diagram illustrating an example associated with a radio resource control (RRC) configuration for default power control parameters, in accordance with the present disclosure.

FIG. 6 is a diagram illustrating examples associated with per-TRP-and-panel power control parameters, in accordance with the present disclosure.

FIG. 7 is a diagram illustrating an example associated with a time offset with multiple physical downlink control channel (PDCCH) reception occasions, in accordance with the present disclosure.

FIGS. 8-9 are diagrams illustrating example processes associated with uplink channel transmissions using per-TRP-and-panel power control parameters, in accordance with the present disclosure.

FIG. 10-11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

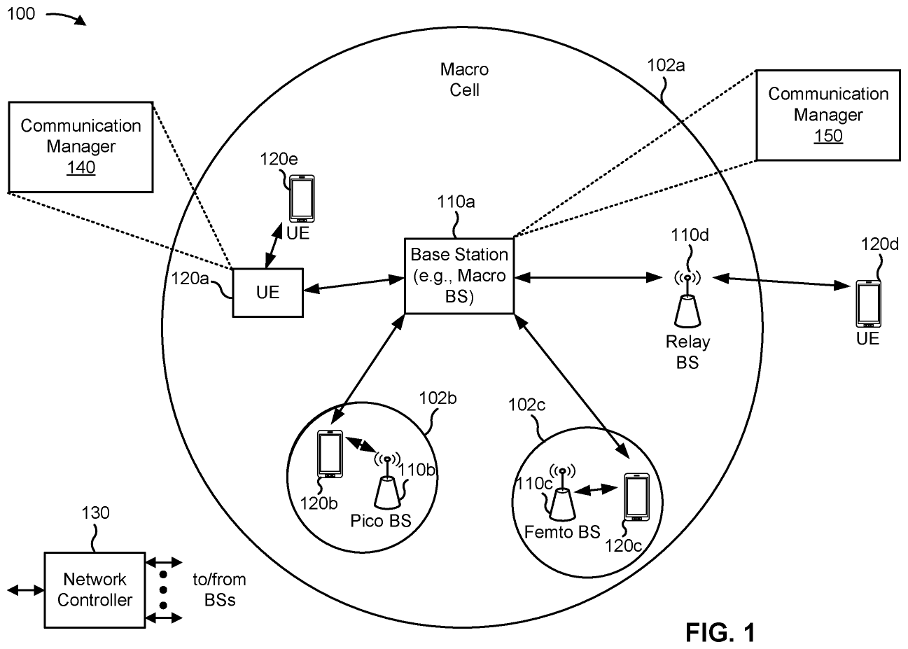

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, a UE (e.g., UE 120) may include a communication manager 140. As described in more detail elsewhere herein, the communication manager 140 may transmit, to a base station, a beam failure recovery request based at least in part on a beam failure between a TRP of the base station and a panel of the UE; receive, from the base station, a beam failure recovery response based at least in part on the beam failure recovery request; and perform, to the base station, an uplink channel transmission based at least in part on per-TRP-and-panel power control parameters that are associated with the TRP and the panel. Additionally, or alternatively, the communication manager 140 may perform one or more other operations described herein.

In some aspects, a base station (e.g., base station 110) may include a communication manager 150. As described in more detail elsewhere herein, the communication manager 150 may receive, from a UE, a beam failure recovery request based at least in part on a beam failure between a TRP of the base station and a panel of the UE; transmit, to the UE, a beam failure recovery response based at least in part on the beam failure recovery request; and receive, from the UE, an uplink channel transmission based at least in part on per-TRP-and-panel power control parameters that are associated with the TRP and the panel. Additionally, or alternatively, the communication manager 150 may perform one or more other operations described herein.

As indicated above, FIG. 1 is provided as an example. Other examples may differ from what is described with regard to FIG. 1.

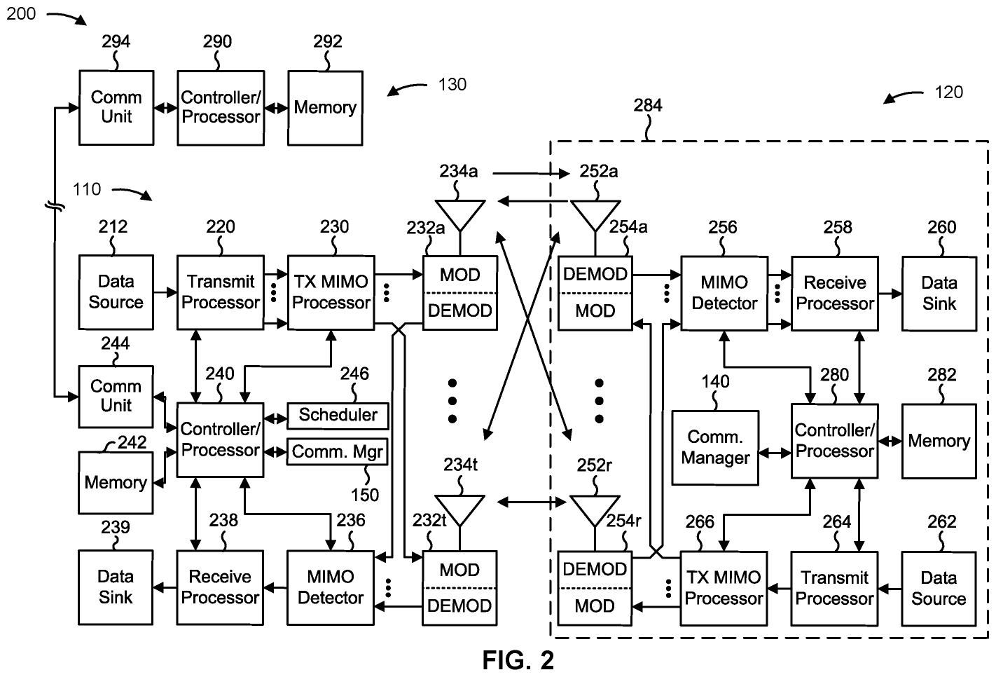

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MC S(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

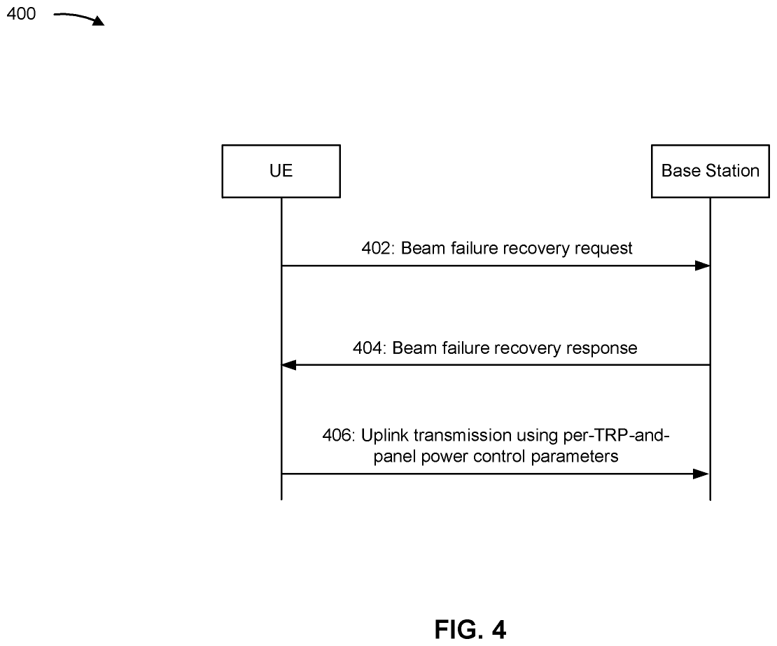

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-9).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-9).

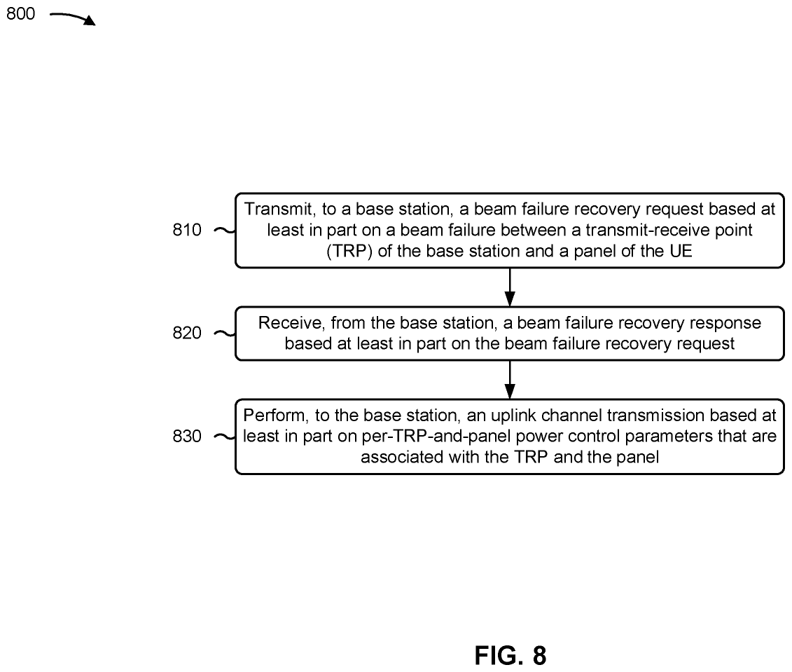

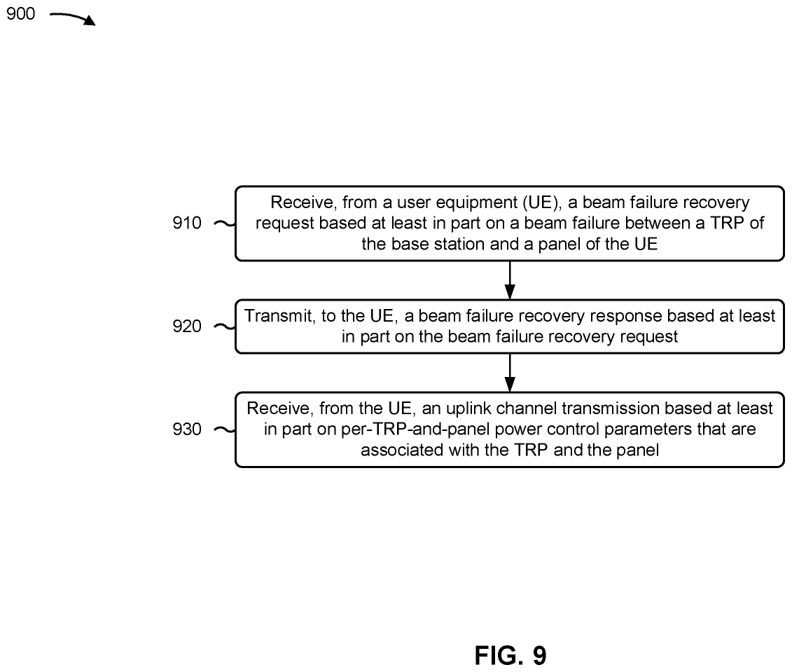

Controller/processor 240 of base station 110, controller/processor 280 of UE 120, and/or any other component(s) of FIG. 2 may perform one or more techniques associated with uplink channel transmissions using per-TRP-and-panel power control parameters, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, a UE (e.g., UE 120) includes means for transmitting, to a base station, a beam failure recovery request based at least in part on a beam failure between a TRP of the base station and a panel of the UE; means for receiving, from the base station, a beam failure recovery response based at least in part on the beam failure recovery request; and/or means for performing, to the base station, an uplink channel transmission based at least in part on per-TRP-and-panel power control parameters that are associated with the TRP and the panel. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a base station (e.g., base station 110) includes means for receiving, from a UE, a beam failure recovery request based at least in part on a beam failure between a TRP of the base station and a panel of the UE; means for transmitting, to the UE, a beam failure recovery response based at least in part on the beam failure recovery request; and/or means for receiving, from the UE, an uplink channel transmission based at least in part on per-TRP-and-panel power control parameters that are associated with the TRP and the panel. The means for the base station to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

During a link recovery procedure, for a primary cell (PCell) or a primary secondary cell (PSCell), after 28 symbols from a last symbol of a first PDCCH reception for which a UE detects a downlink control information (DCI) format, and until the UE receives an indication of physical uplink control channel (PUCCH) spatial relation information (PUCCH-SpatialRelationInfo) for PUCCH resources, the UE may transmit a PUCCH on a same cell as a physical random access channel (PRACH) transmission. The UE may receive an activation command for the PUCCH spatial relation information, or the UE may be provided the PUCCH spatial relation information for the PUCCH resources. The PUCCH spatial relation information may indicate a spatial setting for the PUCCH transmission. The UE may transmit the PUCCH on the same cell as the PRACH transmission using a same spatial filter as for a last PRACH transmission, and based at least in part on a power level. The UE may determine the power level based at least in part on various power control parameters, such as qᵤ, q_{d}, and l, where qᵤ is associated with a PUCCH power value, q_{d} represents a reference signal resource index associated with a downlink pathloss estimate calculated by the UE, and l represents a closed loop index. In some cases, qᵤ=0, q_{d}=q_{new}, and l=0, where q_{new} represents a new reference signal resource index (e.g., associated with a new candidate beam). The first PDCCH reception may be in a search space set provided by a recovery search space identifier (recoverySearchSpaceId). The DCI format may be with a cyclic redundancy check (CRC) scrambled by a cell radio network temporary identifier (C-RNTI) or a modulation and coding scheme cell radio network temporary identifier (MCS-C-RNTI).

During a link recovery procedure, for a PCell or a PSCell, after 28 symbols from a last symbol of a first PDCCH reception in a search space set provided by recoverySearchSpaceId where a UE detects a DCI format with CRC scrambled by a C-RNTI or an MCS-C-RNTI, the UE may assume the same antenna port quasi co-location (QCL) parameters as compared to index q_{new} for PDCCH monitoring in a control resource set (CORESET) with index 0.

During a link recovery procedure, after 28 symbols from a last symbol of a PDCCH reception with a DCI format scheduling a physical uplink shared channel (PUSCH) transmission with a same hybrid automatic repeat request (HARD) process number as for a first PUSCH transmission and having a toggled new data indicator (NDI) field value, a UE may monitor a PDCCH in a plurality of CORESETs. The UE may monitor the PDCCH in the plurality of CORESETs on SCell(s) indicated by a medium access control control element (MAC-CE) using antenna port quasi co-location parameters. The UE may transmit a PUCCH on a PUCCH-SCell using a same spatial domain filter as compared to index q_{new} for periodic channel state information reference signal (CSI-RS) or synchronization signal (SS)/physical broadcast channel (PBCH) block reception, and based at least in part on a power level. The UE may determine the power level based at least in part on various power control parameters, such as qᵤ=0, q_{d}=q_{new}, and l=0. The UE may transmit the PUCCH when the UE is provided with PUCCH spatial relation information for the PUCCH, the PUCCH with a link recovery request was either not transmitted or was transmitted on a PCell or a PSCell, and the PUSCH-SCell is included in the SCell(s) indicated by the MAC-CE. A subcarrier spacing (SCS) configuration for the 28 symbols may be a smallest of SCS configurations of an active downlink bandwidth part for a PDCCH reception and of active downlink bandwidth part(s) of the SCell(s).

For a PUCCH multi-TRP operation in FR2, separate power control parameters for different TRPs may be supported. The power control parameters may be associated via PUCCH spatial relation information, which may enable the separate power control parameters for the different TRPs. For a per-TRP closed-loop power control for a PUCCH, a transmit power control (TPC) command with a closed loop index value associated with first PUCCH spatial relation information may be different than a TPC with a closed loop index value associated with second PUCCH spatial relation information.

For a PUSCH multi-TRP operation, closed loop index values may be different for a per-TRP closed-loop power control for the PUSCH. In a first option, a single TPC field may be used in DCI formats 0_1/0_2, and a TPC value may be applied for two PUSCH beams. In a second option, a single TPC field may be used in DCI formats 0_1/0_2, and a TPC value may be applied for one of two PUSCH beams at a slot. In a third option, a second TPC field may be added in DCI formats 0_1/0_2. In a fourth option, a single TPC field may be used in DCI formats 0_1/0_2, and may indicate two TPC values applied to two PUSCH beams, respectively.

During a multi-TRP beam failure recovery, a beam failure recovery request (BFRQ) MAC-CE may convey information associated with failed component carrier indices, a new candidate beam for a failed TRP or component carrier, and/or an indication of whether the new candidate beam is found. The BFRQ MAC-CE may indicate TRP failure(s) and information associated with the TRP failure(s). Further, the BFRQ MAC-CE may indicate a corresponding beam failure recovery procedure and/or an applicable cell type, such as an SCell or a special cell.

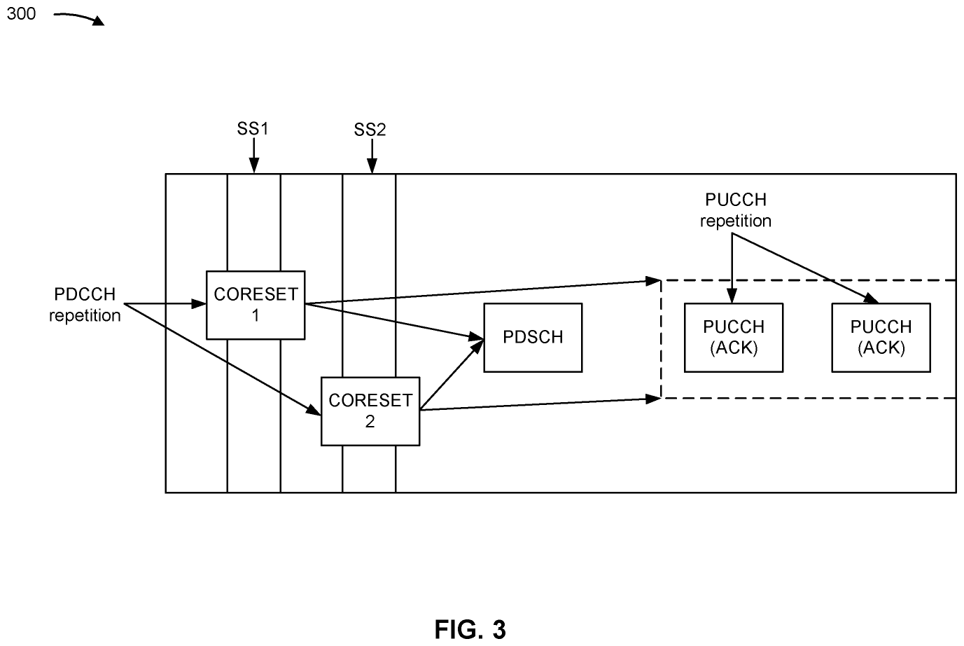

FIG. 3 is a diagram illustrating an example 300 associated with downlink channel and uplink channel repetitions, in accordance with the present disclosure.

As shown in FIG. 3, a PDCCH may be repeated in a plurality of CORESETs. For example, a first PDCCH repetition may be transmitted in a first CORESET, and a second PDCCH repetition may be transmitted in a second CORESET. The first PDCCH repetition and/or the first CORESET may be associated with a first SS, and the second PDCCH repetition and/or the second CORESET may be associated with a second SS. The PDCCH may be associated with a beam failure recovery response. Further, a PUCCH indicating acknowledgements (ACKs) may be repeated. For example, a first PUCCH repetition may be transmitted based at least in part on the first PDCCH repetition, and a second PUCCH repetition may be transmitted based at least in part on the second PDCCH repetition.

As indicated above, FIG. 3 is provided as an example. Other examples may differ from what is described with regard to FIG. 3.

Prior to a beam failure recovery, a UE may receive a first DCI from a base station. The first DCI may be associated with first PUCCH resources. The UE may transmit a first PUCCH to the base station based at least in part on the first DCI. After a period of time, the UE may transmit a BFRQ to the base station. The base station may transmit a second DCI to the UE. The second DCI may indicate a beam failure recovery response to the UE. The base station may subsequently transmit a third DCI to the UE. The third DCI may indicate second PUCCH resources. The UE may transmit a second PUCCH to the base station based at least in part on the third DCI. The UE may transmit the second PUCCH based at least in part on a beam reset and/or updated power control parameters. The second DCI associated with the beam failure recovery response and the third DCI associated with the second PUCCH resources may be separated by 28 symbols.

During the beam failure recovery, the UE may report new beam information to the base station in the BFRQ. The base station may transmit, to the UE, the beam failure recovery response based at least in part on the new beam information. After receiving the beam failure recovery response from the base station, the UE may reset a PUCCH impacted by a beam failure to be associated with a single set of default power control parameters.

In a multi-TRP/panel configuration, the base station may be associated with multiple TRPs and the UE may be associated with multiple panels. In the multi-TRP/panel configuration, a first TRP of the base station may be associated with a first panel of the UE, and a second TRP of the base station may be associated with a second panel of the UE. However, in the multi-TRP/panel configuration, different TRPs/panels may be associated with separate beam indications, separate power controls, and/or separate beam failure recovery processes. As a result, the single set of default power control parameters associated with the PUCCH impacted by the beam failure may not be suitable for the multi-TRP/panel configuration.

Further, a DCI may be linked to multiple PDCCH reception occasions in the case of PDCCH repetition. The DCI may be the second DCI associated with the beam failure recovery response. In the case of PDCCH repetition, the beam failure recovery response may be repeated at the multiple PDCCH reception occasions. Typically, the second DCI associated with the beam failure recovery response and the third DCI associated with the second PUCCH transmission may be separated by a duration of 28 symbols. However, when the beam failure recovery response is repeated in the multiple PDCCH reception occasions, an exact timing of a PDCCH reception may not be defined. In other words, when the beam failure recovery response is repeated, the UE may be unable to determine when to start the 28 symbol duration that separates the second DCI associated with the beam failure recovery response and the third DCI associated with the second PUCCH transmission.

In various aspects of techniques and apparatuses described herein, a UE may transmit, to a base station, a per-TRP beam failure recovery request based at least in part on a beam failure between a TRP of the base station and a panel of the UE. The UE may receive, from the base station, a beam failure recovery response based at least in part on the beam failure recovery request. The UE may perform, to the base station, a PUCCH transmission based at least in part on per-TRP-and-panel power control parameters that are associated with the TRP and the panel. In some aspects, the UE may determine the per-TRP-and-panel power control parameters based at least in part on identifier(s) associated with the TRP and the panel. In some aspects, the UE may be configured with the per-TRP-and-panel power control parameters (e.g., by the base station). As a result, the PUCCH transmission may be performed using the per-TRP-and-panel power control parameters, which may account for separate beam indications, separate power control, and/or separate beam failure recoveries associated with different TRPs and panels in a multi-TRP/panel configuration.

FIG. 4 is a diagram illustrating an example 400 associated with uplink channel transmissions using per-TRP-and-panel power control parameters, in accordance with the present disclosure. As shown in FIG. 4, example 400 includes communication between a UE (e.g., UE 120) and a base station (e.g., base station 110). In some aspects, the UE and the base station may be included in a wireless network, such as wireless network 100.

As shown by reference number 402, the UE may transmit, to the base station, a beam failure recovery request based at least in part on a beam failure between a TRP of the base station and a panel of the UE. A mapping between a panel and a TRP may be a one-to-one mapping. For example, the TRP may be a first TRP and the panel may be a first panel, or the TRP may be a second TRP and the panel may be a second panel. The beam failure between the TRP and the panel may be applied for between either the first TRP and the first panel or for between the second TRP and the second panel. As another example, the TRP may be a first TRP and the panel may be a second panel, or the TRP may be a second TRP and the panel may be a first panel. The beam failure between the TRP and the panel may be applied for between either the first TRP and the second panel or for between the second TRP and the first panel. In some aspects, the UE may transmit the beam failure recovery request via a MAC-CE to the base station. In some aspects, the beam failure recovery request may be a per-TRP beam failure recovery request, as the beam failure recovery request may be associated with a specific TRP of the base station and a specific panel of the UE (e.g., the first TRP and the first panel, or the second TRP and the second panel).

In some aspects, the beam failure recovery request may be associated with a per-TRP beam failure recovery. The per-TRP beam failure recovery may include a PCell per-TRP beam failure recovery or a PUCCH-SCell per-TRP beam failure recovery.

As shown by reference number 404, the UE may receive, from the base station, a beam failure recovery response based at least in part on the beam failure recovery request (e.g., the per-TRP beam failure recovery request). The UE may receive the beam failure recovery response in DCI. The beam failure recovery response may be associated with a PDCCH reception occasion. In some aspects, when PDCCH repetitions are enabled, the beam failure recovery response may be repeated and may be associated with multiple PDCCH reception occasions.

As shown by reference number 406, the UE may perform, to the base station, a PUCCH transmission based at least in part on per-TRP-and-panel power control parameters that are associated with the TRP and the panel. In some aspects, the UE may determine the per-TRP-and-panel power control parameters for the PUCCH transmission after receiving the beam failure recovery response from the base station. Alternatively, the UE may be configured with the per-TRP-and-panel power control parameters (e.g., by the base station). In some aspects, the UE may reset to a new beam based at least in part on the beam failure between the TRP of the base station and the panel of the UE, and the UE may perform the PUCCH transmission using the new beam.

In some aspects, the per-TRP-and-panel power control parameters may include a first power control parameter and a second power control parameter. The first power control parameter (e.g., qᵤ) may indicate a nominal power level with an identifier (e.g., a lowest identifier) associated with the TRP and the panel, and the second power control parameter (e.g., l) may indicate a closed loop index with an identifier (e.g., a lowest identifier) associated with the TRP and the panel.

In some aspects, during a per-TRP beam failure recovery, the UE may transmit the PUCCH on a PCell or a PUCCH-SCell using a spatial domain filter (e.g., a beam). The spatial domain filter may be the same as a spatial domain filter corresponding to index q_{new} for periodic CSI-RS or SS/PBCH block reception associated with a TRP, where the TRP may be associated with the per-TRP beam failure recovery. The UE may transmit the PUCCH based at least in part on a power level. The UE may determine the power level based at least in part on the per-TRP-and-panel power control parameters, which may include qᵤ, q_{d}=q_{new}, and l, where qᵤ is a power (P0) with a lowest identifier associated with the TRP/panel, q_{d} represents a reference signal resource index associated with a downlink pathloss estimate calculated by the UE, q_{new} represents a new reference signal resource index (e.g., associated with a new candidate beam), and l is a closed loop index with a lowest identifier associated with the TRP/panel. In some aspects, the per-TRP beam failure recovery may be a PCell per-TRP beam failure recovery or a PUCCH-SCell per-TRP beam failure recovery.

In some aspects, the UE may receive, from the base station, a configuration that indicates the per-TRP-and-panel power control parameters. The configuration may indicate a first set of parameters associated with the first TRP of the base station and the first panel of the UE. The configuration may indicate the second set of parameters associated with the second TRP of the base station and the second panel of the UE. In some aspects, the first set of parameters may indicate a first set of beam failure detection reference signals (BFD-RSs), a first set of new beam identification reference signals (NBI-RSs), and a first set of default power control parameters. In some aspects, the first set of parameters may also indicate a first set of CORESET IDs. For example, the first set of parameters may indicate a first set of CORESET IDs when the first set of BFD-RSs is absent. The second set of parameters may indicate a second set of BFD-RSs, a second set of NBI-RSs, and a second set of default power control parameters. In some aspects, the second set of parameters may also indicate a second set of CORESET IDs. For example, the second set of parameters may indicate a second set of CORESET IDs when the second set of BFD-RSs is absent. The first set of default power control parameters or the second set of default power control parameters may correspond to the per-TRP-and-panel power control parameters associated with per-TRP-and-panel beam failure recovery.

In some aspects, to enable a per-TRP beam failure recovery, the UE may be configured with two sets of BFD-RSs. Alternatively, the UE may be configured with two sets of CORESET IDs, which may be used to determine two sets of BFD-RSs. The UE may be configured with two sets of NBI-RSs. The UE may be configured with two sets of power control parameters to transmit a PUCCH on a PCell or a PUCCH-SCell after receiving a beam failure recovery response from a base station. The base station may configure the two sets of BFD-RSs, the two sets of NBI-RSs, and the two sets of power control parameters for the UE. A first set of BFD-RSs, a first set of NBI-RSs, and a first set of default power control parameters may form a first association. A second set of BFD-RSs, a second set of NBI-RSs, and a second set of default power control parameters may form a second association. The UE may apply an i-th (i=1, 2) set of BFD-RSs to detect a beam failure event associated with a TRP. The UE may apply an i-th set of NBI-RSs to identify a new beam information q_{new} when the beam failure event is detected with the TRP. The UE may apply an i-th set of default power control parameters for a PUCCH transmission after a beam failure recovery response is received from a base station. In particular, the UE may apply an i-th set of default power control parameters and the identified new beam information q_{new} for a PUCCH transmission, if associated with the TRP, after 28 symbols from a last symbol of a PDCCH reception identified as a beam failure recovery response. Additionally, for beam failure recovery in an SCell, after 28 symbols from a last symbol of a PDCCH reception identified as the beam failure recovery response, the UE may monitor PDCCHs in CORESETs associated with the TRP, on the SCell(s) indicated by a MAC CE for a beam failure recovery request using same antenna port quasi co-location parameters as the ones associated with the corresponding index(es) qnew, if any.

In some aspects, the per-TRP beam failure recovery may be a PCell per-TRP beam failure recovery or a PUCCH-SCell per-TRP beam failure recovery. For example, for beam failure recovery in a PCell or a PScell, a beam failure recovery response may be identified as a first PDCCH received in a search space set provided by a recoverySearchSpaceId and in a CORESET dedicated for beam failure recovery where a UE detects a DCI format with CRC scrambled by a C-RNTI or an MCS-C-RNTI after four slots from a transmission of a beam failure recovery request. As another example, for beam failure recovery in an SCell, a beam failure recovery response may be identified as a PDCCH reception with a DCI format scheduling a PUSCH transmission with a same HARQ process number as for the transmission of the PUSCH carrying a MAC-CE for a beam failure recovery request and having a toggled NDI field value.

In some aspects, the beam failure recovery response, which may be received based at least in part on a PDCCH, may be associated with a plurality of PDCCH reception occasions when PDCCH repetitions are enabled. For example, the PDCCH with the beam failure recovery response may be transmitted repeatedly in multiple PDCCH reception occasions, and the multiple PDCCH reception occasions may be configured for a PDCCH by RRC signaling. A PDCCH reception occasion of the plurality of PDCCH reception occasions may start a symbol count, where the symbol count may be associated with a quantity of symbols that separates the beam failure recovery response and a reset to a new beam or a set of power control parameters. The new beam may be for the PUCCH transmission, which may be performed using the per-TRP-and-panel power control parameters. In some aspects, the PDCCH reception occasion may be a first actual transmitted PDCCH repetition or a last actual transmitted PDCCH repetition. In some aspects, the PDCCH reception occasion may be a first configured PDCCH repetition or a last configured PDCCH repetition. In some aspects, the PDCCH reception occasion may be a first scheduled PDCCH repetition or a last scheduled PDCCH repetition.

In some aspects, when PDCCH repetitions are enabled, and one DCI (e.g., a DCI associated with a beam failure recovery response transmitted by the base station) is associated with multiple PDCCH occasions, a timing for a 28-symbol duration may be defined. The 28-symbol duration may begin starting from the beam failure recovery response. The 28-symbol duration may start at a last symbol of a PDCCH reception occasion associated with the beam failure recovery response. In some aspects, the timing may be associated with a beam reset timing and/or a power control parameter reset timing, which may occur at least 28 symbols after the beam failure recovery response.

In some aspects, in a first option, the last symbol of the PDCCH reception occasion may be based at least in part on a PDCCH occasion associated with a first or last actually transmitted PDCCH repetition. Some PDCCH occasions of a PDCCH for a beam failure recovery response may be dropped or canceled due to a collision, or based at least in part on an overlap with a synchronization signal block (SSB) reception, a slot format indication (e.g., uplink slots), a dynamic grant, or a semi-persistent scheduled (SPS) physical downlink shared channel (PDSCH). For example, in this case, actually transmitted PDCCH repetitions may include only PDCCH reception occasions of the PDCCH for a beam failure recovery response after dropping or cancellation. In some aspects, in a second option, the last symbol of the PDCCH reception occasion may be based at least in part on a PDCCH occasion associated with a first or a last configured PDCCH repetition. For example, in this case, configured PDCCH repetitions may include PDCCH reception occasions of the PDCCH for a beam failure recovery response without considering a dropping or cancellation. In some aspects, in a third option, the last symbol of the PDCCH reception occasion may be based at least in part on a PDCCH occasion associated with a first or a last scheduled PDCCH repetition, where a quantity of PDCCH occasions may be changed by scheduling. A quantity of PDCCH repetitions may be based at least in part on other scheduling signalling, such as a MAC-CE indication. In this case, scheduled PDCCH repetitions may include only PDCCH reception occasions of the PDCCH for a beam failure recovery response indicated by the scheduling.

In some aspects, after 28 symbols from receiving the beam failure recovery response via a PDCCH, the UE may reset a PDCCH/PUCCH beam and power control parameters for a failed TRP or a failed component carrier when a new candidate beam q_{new} is reported for the PDCCH/PUCCH beam. When PDCCH repetitions are enabled and the PDCCH for beam failure recovery response is to be received in multiple PDCCH reception occasions, the 28-symbol duration for the UE to reset a new beam (e.g., QCL assumption, or spatial transmit filter) for CORESETs or PUCCHs or to reset power control parameters for PUCCHs may begin from a last configured PDCCH repetition associated with the beam failure recovery response. In one example, for a PCell or a PSCell, after 28 symbols from a last symbol of a first received PDCCH, or a last symbol of a last configured PDCCH reception occasion in multiple PDCCH reception occasions associated with a first received PDCCH, in a search space set provided by recoverySearchSpaceId for which the UE detects a DCI format with CRC scrambled by C-RNTI or MCS-C-RNTI and until the UE receives an activation command for PUCCH-SpatialRelationInfo or is provided PUCCH-SpatialRelationInfo for PUCCH resource(s), the UE may transmit a PUCCH on a same cell as a PRACH transmission using a same spatial filter as for a last PRACH transmission. In another example, after 28 symbols from a last symbol of a received PDCCH, or a last symbol of the last configured PDCCH reception occasion in multiple PDCCH reception occasions associated with a first received PDCCH, with a DCI format scheduling a PUSCH transmission with a same HARQ process number as for the transmission of the first PUSCH and having a toggled NDI field value, the UE may monitor a PDCCH in CORESETs associated with TRPs or SCells indicated by a MAC CE using same antenna port quasi co-location parameters as the ones associated with corresponding index(es) q_{new}, if any, and may transmit a PUCCH on a PUCCH-SCell using a same spatial domain filter as the one corresponding to q_{new} for periodic CSI-RS or SS/PBCH block reception.

In some aspects, the UE may receive a beam indication. The beam indication may be indicated by a MAC-CE or DCI, and the beam indication may be for a transmission configuration indicator (TCI) indication or spatial relation information for at least one channel. For example, the UE may receive an activation command (e.g., by MAC-CE) for PUCCH-SpatialRelationInfo in a beam failure recovery. When the UE receives a beam indication for providing QCL information or TX spatial filter to a channel, the UE may apply the beam indication starting from a first slot that is after a slot k+X, where k is a slot where the UE would transmit a PUCCH or PUSCH occasion with an acknowledgment for the beam indication, and X may be a time offset value. The PUCCH or PUSCH with the acknowledgment for the beam indication may be transmitted repeatedly and associated with multiple PUCCH or PUSCH transmission occasions, and the multiple PUCCH or PUSCH transmission occasions may be configured or scheduled. In some aspects, the PUCCH or PUSCH transmission occasion used to determine the slot k may be a first actual transmitted PUCCH or PUSCH repetition or a last actual transmitted PUCCH or PUSCH repetition. In some aspects, the PUCCH or PUSCH transmission occasion may be a first configured PUCCH or PUSCH repetition or a last configured PUCCH or PUSCH repetition. In some aspects, the PUCCH or PUSCH reception occasion may be a first scheduled PUCCH repetition or a last scheduled PUCCH repetition.

As indicated above, FIG. 4 is provided as an example. Other examples may differ from what is described with regard to FIG. 4.

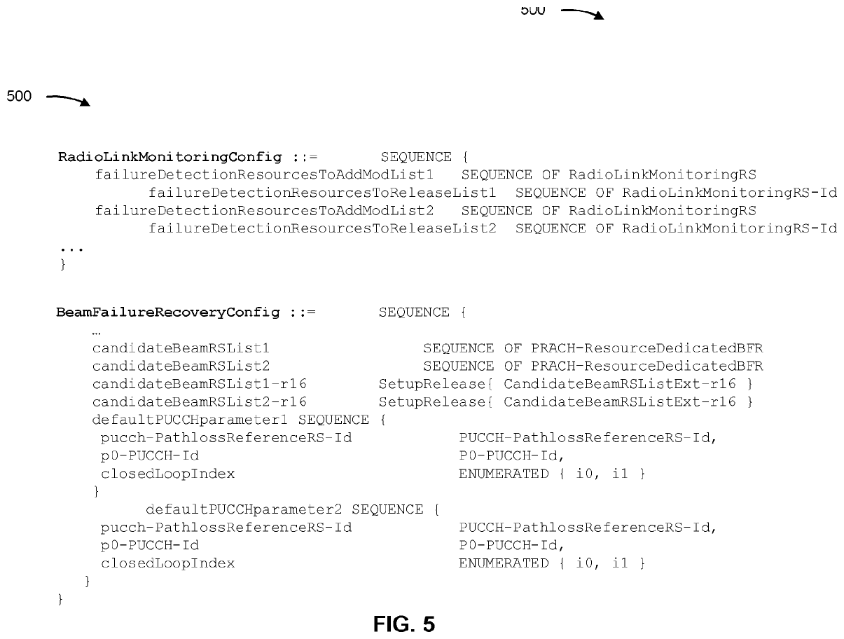

FIG. 5 is a diagram illustrating an example 500 associated with an RRC configuration for default power control parameters, in accordance with the present disclosure.

In some aspects, the RRC configuration may indicate a radio link monitoring configuration. The radio link monitoring configuration may indicate a first failure detection resources to add or modify list (failureDetectionResourcesToAddModList1), and a first failure detection resources to release list (failureDetectionResourcesToReleaseList1). The radio link monitoring configuration may indicate a second failure detection resources to add or modify list (failureDetectionResourcesToAddModList2), and a second failure detection resources to release list (failureDetectionResourcesToReleaseList2).

In some aspects, the RRC configuration may indicate a beam failure recovery configuration. The beam failure recovery configuration may indicate a first candidate beam reference signal list (candidateBeamRSList1-r16), which may be associated with the first failure detection resources to add or modify list and the first failure detection resources to release list. The beam failure recovery configuration may indicate a second candidate beam reference signal list (candidateBeamRSList2-r16), which may be associated with the second failure detection resources to add or modify list and the second failure detection resources to release list.

In some aspects, the first candidate beam reference signal list may be associated with first default PUCCH parameters (defaultPUCCHparameter1). The first default PUCCH parameters may include a PUCCH pathloss reference signal identifier (pucch-PathlossReferenceRS-Id), a P0 PUCCH identifier (p0-PUCCH-Id), and a closed loop index (closedLoopIndex). The second candidate beam reference signal list may be associated with second default PUCCH parameters (defaultPUCCHparameter2). The second default PUCCH parameters may include a PUCCH pathloss reference signal identifier, a P0 PUCCH identifier, and a closed loop index.

As indicated above, FIG. 5 is provided as an example. Other examples may differ from what is described with regard to FIG. 5.

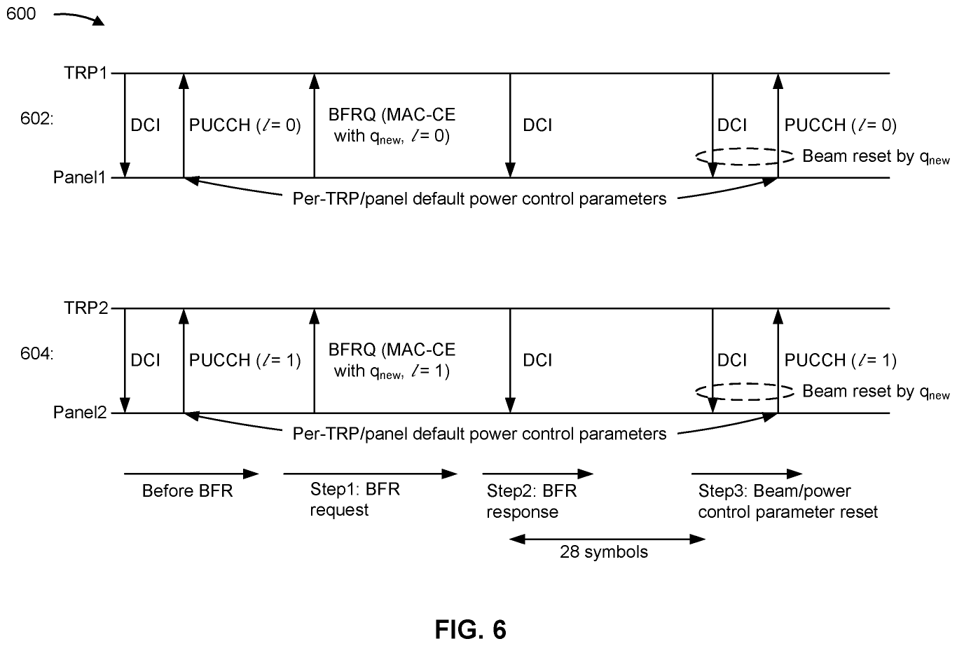

FIG. 6 is a diagram illustrating an example 600 associated with per-TRP-and-panel power control parameters, in accordance with the present disclosure.

As shown by reference number 602, a first TRP may be associated with a base station and a first panel may be associated with a UE. Before a beam failure recovery, the first TRP may transmit first DCI to the first panel. The first panel may transmit a first PUCCH to the first TRP based at least in part on the first DCI. The first panel may transmit the first PUCCH based at least in part on per-TRP-and-panel power control parameters. For example, a closed loop index (l) included in the per-TRP-and-panel default power control parameters may be zero for the first TRP/panel, and may be associated with a PCell. The first panel may transmit a BFRQ (e.g., via a MAC-CE with q_{new} and l=0) to the first TRP. The first TRP may transmit a beam failure recovery response (e.g., via a second DCI) to the first panel. The first TRP may transmit a third DCI to the first panel. The first panel may transmit a second PUCCH to the first TRP based at least in part on the third DCI and the per-TRP-and-panel power control parameters (e.g., l=0). The UE may reset a beam for transmitting the second PUCCH based at least in part on q_{new}. Further, the second DCI and the third DCI may be separated by about 28 symbols.

As shown by reference number 604, a first TRP may be associated with a base station and a first panel may be associated with a UE. Before a beam failure recovery, the first TRP may transmit first DCI to the first panel. The first panel may transmit a first PUCCH to the first TRP based at least in part on the first DCI. The first panel may transmit the first PUCCH based at least in part on per-TRP-and-panel power control parameters. For example, a closed loop index (l) included in the per-TRP-and-panel power control parameters may be one (1) for the first TRP/panel, and may be associated with a PCell. The first panel may transmit a BFRQ (e.g., via a MAC-CE with q_{new} and l=1) to the first TRP. The first TRP may transmit a beam failure recovery response (e.g., via a second DCI) to the first panel. The first TRP may transmit a third DCI to the first panel. The first panel may transmit a second PUCCH to the first TRP based at least in part on the third DCI and the per-TRP-and-panel power control parameters (e.g., l=1). The UE may reset a beam for transmitting the second PUCCH based at least in part on q_{new}. Further, the second DCI and the third DCI may be separated by about 28 symbols.

As indicated above, FIG. 6 is provided as an example. Other examples may differ from what is described with regard to FIG. 6.

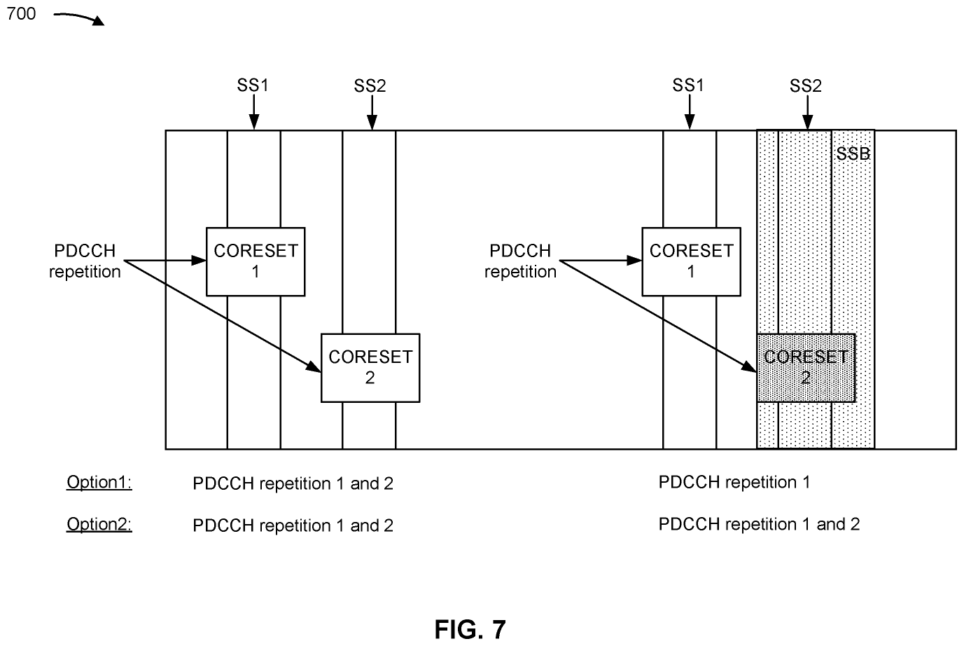

FIG. 7 is a diagram illustrating an example 700 associated with a time offset with multiple PDCCH reception occasions, in accordance with the present disclosure.

As shown in FIG. 7, a PDCCH may be repeated in a plurality of CORESETs. For example, a first PDCCH repetition may be transmitted in a first CORESET, and a second PDCCH repetition may be transmitted in a second CORESET. The first PDCCH repetition and/or the first CORESET may be associated with a first SS, and the second PDCCH repetition and/or the second CORESET may be associated with a second SS. The PDCCH may be associated with a beam failure recovery response. In some aspects, in accordance with a first option, the first PDCCH repetition and the second PDCCH repetition may be transmitted at a first time, and at a second time, only the first PDCCH repetition may be transmitted. In some aspects, in accordance with a second option, the first PDCCH repetition and the second PDCCH repetition may be transmitted at a first time, and at a second time, the first PDCCH repetition and the second PDCCH repetition may be transmitted.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with uplink channel transmissions using per-TRP-and-panel power control parameters.

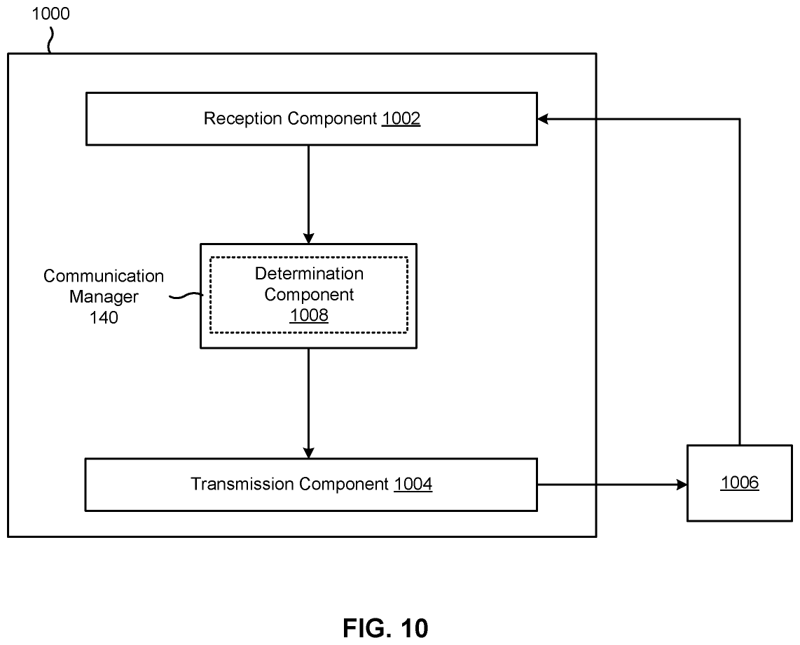

As shown in FIG. 8, in some aspects, process 800 may include transmitting, to a base station, a beam failure recovery request based at least in part on a beam failure between a TRP of the base station and a panel of the UE (block 810). For example, the UE (e.g., using communication manager 140 and/or transmission component 1004, depicted in FIG. 10) may transmit, to a base station, a beam failure recovery request based at least in part on a beam failure between a TRP of the base station and a panel of the UE, as described above.

As further shown in FIG. 8, in some aspects, process 800 may include receiving, from the base station, a beam failure recovery response based at least in part on the beam failure recovery request (block 820). For example, the UE (e.g., using communication manager 140 and/or reception component 1002, depicted in FIG. 10) may receive, from the base station, a beam failure recovery response based at least in part on the beam failure recovery request, as described above.

As further shown in FIG. 8, in some aspects, process 800 may include performing, to the base station, an uplink channel transmission based at least in part on per-TRP-and-panel power control parameters that are associated with the TRP and the panel (block 830). For example, the UE (e.g., using communication manager 140 and/or transmission component 1004, depicted in FIG. 10) may perform, to the base station, an uplink channel transmission based at least in part on per-TRP-and-panel power control parameters that are associated with the TRP and the panel, as described above.

Process 800 may include additional aspects, such as any single aspect or any combination of aspects described below and/or in connection with one or more other processes described elsewhere herein.

In a first aspect, process 800 includes determining the per-TRP-and-panel power control parameters, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

In a second aspect, alone or in combination with the first aspect, the beam failure recovery request is associated with a per-TRP beam failure recovery, wherein the per-TRP beam failure recovery includes a per-TRP beam failure recovery in a primary cell or a per-TRP beam failure recovery in a secondary cell configured with a physical uplink control channel.

In a third aspect, alone or in combination with one or more of the first and second aspects, process 800 includes receiving, from the base station, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

In a fourth aspect, alone or in combination with one or more of the first through third aspects, the first set of parameters indicates a first set of beam failure detection reference signals, a first set of new beam identification reference signals, and a first set of default power control parameters, and the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

In a fifth aspect, alone or in combination with one or more of the first through fourth aspects, the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

In a sixth aspect, alone or in combination with one or more of the first through fifth aspects, the downlink channel reception occasion is a first actual transmitted downlink channel repetition or a last actual transmitted downlink channel repetition.

In a seventh aspect, alone or in combination with one or more of the first through sixth aspects, the downlink channel reception occasion is a first configured downlink channel repetition or a last configured downlink channel repetition.

In an eighth aspect, alone or in combination with one or more of the first through seventh aspects, the downlink channel reception occasion is a first scheduled downlink channel repetition or a last scheduled downlink channel repetition.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with uplink channel transmissions using per-TRP-and-panel power control parameters.

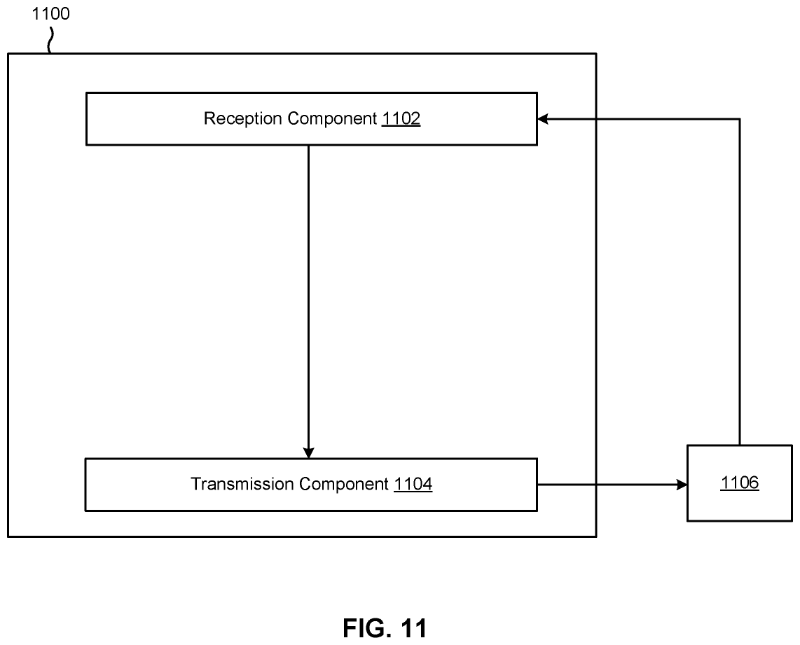

As shown in FIG. 9, in some aspects, process 900 may include receiving, from a UE, a beam failure recovery request based at least in part on a beam failure between a TRP of the base station and a panel of the UE (block 910). For example, the base station (e.g., using communication manager 150 and/or reception component 1102, depicted in FIG. 11) may receive, from a UE, a beam failure recovery request based at least in part on a beam failure between a TRP of the base station and a panel of the UE, as described above.

As further shown in FIG. 9, in some aspects, process 900 may include transmitting, to the UE, a beam failure recovery response based at least in part on the beam failure recovery request (block 920). For example, the base station (e.g., using communication manager 150 and/or transmission component 1104, depicted in FIG. 11) may transmit, to the UE, a beam failure recovery response based at least in part on the beam failure recovery request, as described above.

As further shown in FIG. 9, in some aspects, process 900 may include receiving, from the UE, an uplink channel transmission based at least in part on per-TRP-and-panel power control parameters that are associated with the TRP and the panel (block 930). For example, the base station (e.g., using communication manager 150 and/or reception component 1102, depicted in FIG. 11) may receive, from the UE, an uplink channel transmission based at least in part on per-TRP-and-panel power control parameters that are associated with the TRP and the panel, as described above.

Process 900 may include additional aspects, such as any single aspect or any combination of aspects described below and/or in connection with one or more other processes described elsewhere herein.

In a first aspect, the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

In a second aspect, alone or in combination with the first aspect, process 900 includes transmitting, to the UE, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

In a third aspect, alone or in combination with one or more of the first and second aspects, the first set of parameters indicates a first set of beam failure detection reference signals, a first set of new beam identification reference signals, and a first set of default power control parameters, and the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

In a fourth aspect, alone or in combination with one or more of the first through third aspects, the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

In a fifth aspect, alone or in combination with one or more of the first through fourth aspects, the downlink channel reception occasion is a first actual transmitted downlink channel repetition or a last actual transmitted downlink channel repetition, the downlink channel reception occasion is a first configured downlink channel repetition or a last configured downlink channel repetition, or the downlink channel reception occasion is a first scheduled downlink channel repetition or a last scheduled downlink channel repetition.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a determination component 1008, among other examples.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit, to a base station, a beam failure recovery request based at least in part on a beam failure between a TRP of the base station and a panel of the UE. The reception component 1002 may receive, from the base station, a beam failure recovery response based at least in part on the beam failure recovery request. The transmission component 1004 may perform, to the base station, an uplink channel transmission based at least in part on per-TRP-and-panel power control parameters that are associated with the TRP and the panel.

The determination component 1008 may determine the per-TRP-and-panel power control parameters, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

The reception component 1002 may receive, from the base station, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The reception component 1102 may receive, from a UE, a beam failure recovery request based at least in part on a beam failure between a TRP of the base station and a panel of the UE. The transmission component 1104 may transmit, to the UE, a beam failure recovery response based at least in part on the beam failure recovery request. The reception component 1102 may receive, from the UE, an uplink channel transmission based at least in part on per-TRP-and-panel power control parameters that are associated with the TRP and the panel.

The transmission component 1104 may transmit, to the UE, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting, to a base station, a beam failure recovery request based at least in part on a beam failure between a transmit-receive point (TRP) of the base station and a panel of the UE; receiving, from the base station, a beam failure recovery response based at least in part on the beam failure recovery request; and performing, to the base station, an uplink channel transmission based at least in part on per-TRP-and-panel power control parameters that are associated with the TRP and the panel.

Aspect 2: The method of Aspect 1, further comprising: determining the per-TRP-and-panel power control parameters, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

Aspect 3: The method of any of Aspects 1 through 2, wherein the beam failure recovery request is associated with a per-TRP beam failure recovery, wherein the per-TRP beam failure recovery includes a per-TRP beam failure recovery in a primary cell or a per-TRP beam failure recovery in a secondary cell configured with a physical uplink control channel.

Aspect 4: The method of any of Aspects 1 through 3, further comprising: receiving, from the base station, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the Aspect 5: The method of Aspect 4, wherein: the first set of parameters indicates a first set of beam failure detection reference signals, a first set of new beam identification reference signals, and a first set of default power control parameters; and the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

Aspect 6: The method of any of Aspects 1 through 5, wherein the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

Aspect 7: The method of Aspect 6, wherein the downlink channel reception occasion is a first actual transmitted downlink channel repetition or a last actual transmitted downlink channel repetition.

Aspect 8: The method of Aspect 6, wherein the downlink channel reception occasion is a first configured downlink channel repetition or a last configured downlink channel repetition.

Aspect 9: The method of Aspect 6, wherein the downlink channel reception occasion is a first scheduled downlink channel repetition or a last scheduled downlink channel repetition.

Aspect 10: A method of wireless communication performed by a base station, comprising: receiving, from a user equipment (UE), a beam failure recovery request based at least in part on a beam failure between a transmit-receive point (TRP) of the base station and a panel of the UE; transmitting, to the UE, a beam failure recovery response based at least in part on the beam failure recovery request; and receiving, from the UE, an uplink channel transmission based at least in part on per-TRP-and-panel power control parameters that are associated with the TRP and the panel.

Aspect 11: The method of Aspect 10, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

Aspect 12: The method of any of Aspects 10 through 11, further comprising: transmitting, to the UE, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

Aspect 13: The method of Aspect 12, wherein: the first set of parameters indicates a first set of beam failure detection reference signals, a first set of new beam identification reference signals, and a first set of default power control parameters; and the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

Aspect 14: The method of any of Aspects 10 through 13, wherein the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

Aspect 15: The method of Aspect 14, wherein: the downlink channel reception occasion is a first actual transmitted downlink channel repetition or a last actual transmitted downlink channel repetition; the downlink channel reception occasion is a first configured downlink channel repetition or a last configured downlink channel repetition; or the downlink channel reception occasion is a first scheduled downlink channel repetition or a last scheduled downlink channel repetition.

Aspect 16: An apparatus for wireless communication at a device, comprising a processor; memory coupled with the processor; and instructions stored in the memory and executable by the processor to cause the apparatus to perform the method of one or more of Aspects 1-9.

Aspect 17: A device for wireless communication, comprising a memory and one or more processors coupled to the memory, the one or more processors configured to perform the method of one or more of Aspects 1-9.

Aspect 18: An apparatus for wireless communication, comprising at least one means for performing the method of one or more of Aspects 1-9.

Aspect 19: A non-transitory computer-readable medium storing code for wireless communication, the code comprising instructions executable by a processor to perform the method of one or more of Aspects 1-9.

Aspect 20: A non-transitory computer-readable medium storing a set of instructions for wireless communication, the set of instructions comprising one or more instructions that, when executed by one or more processors of a device, cause the device to perform the method of one or more of Aspects 1-9.

Aspect 21: An apparatus for wireless communication at a device, comprising a processor; memory coupled with the processor; and instructions stored in the memory and executable by the processor to cause the apparatus to perform the method of one or more of Aspects 10-15.

Aspect 22: A device for wireless communication, comprising a memory and one or more processors coupled to the memory, the one or more processors configured to perform the method of one or more of Aspects 10-15.

Aspect 23: An apparatus for wireless communication, comprising at least one means for performing the method of one or more of Aspects 10-15.

Aspect 24: A non-transitory computer-readable medium storing code for wireless communication, the code comprising instructions executable by a processor to perform the method of one or more of Aspects 10-15.

Aspect 25: A non-transitory computer-readable medium storing a set of instructions for wireless communication, the set of instructions comprising one or more instructions that, when executed by one or more processors of a device, cause the device to perform the method of one or more of Aspects 10-15.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a base station, a beam failure recovery request based at least in part on a beam failure between a transmit-receive point (TRP) of the base station and a panel of the UE;
receive, from the base station, a beam failure recovery response based at least in part on the beam failure recovery request; and
perform, to the base station, an uplink channel transmission based at least in part on per-TRP-and-panel power control parameters that are associated with the TRP and the panel.

2. The UE of claim 1, wherein the one or more processors are further configured to:
determine the per-TRP-and-panel power control parameters, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

3. The UE of claim 1, wherein the beam failure recovery request is associated with a per-TRP beam failure recovery, wherein the per-TRP beam failure recovery includes a per-TRP beam failure recovery in a primary cell or a per-TRP beam failure recovery in a secondary cell configured with a physical uplink control channel.

4. The UE of claim 1, wherein the one or more processors are further configured to:
receive, from the base station, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

5. The UE of claim 4, wherein:
the first set of parameters indicates a first set of beam failure detection reference signals, a first set of new beam identification reference signals, and a first set of default power control parameters; and
the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

6. The UE of claim 1, wherein the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

7. The UE of claim 6, wherein the downlink channel reception occasion is a first actual transmitted downlink channel repetition or a last actual transmitted downlink channel repetition.

8. The UE of claim 6, wherein the downlink channel reception occasion is a first configured downlink channel repetition or a last configured downlink channel repetition.

9. The UE of claim 6, wherein the downlink channel reception occasion is a first scheduled downlink channel repetition or a last scheduled downlink channel repetition.

10. A base station for wireless communication, comprising:
a memory; and
one or more processors, coupled to the memory, configured to:
receive, from a user equipment (UE), a beam failure recovery request based at least in part on a beam failure between a transmit-receive point (TRP) of the base station and a panel of the UE;
transmit, to the UE, a beam failure recovery response based at least in part on the beam failure recovery request; and
receive, from the UE, an uplink channel transmission based at least in part on per-TRP-and-panel power control parameters that are associated with the TRP and the panel.

11. The base station of claim 10, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

12. The base station of claim 10, wherein the one or more processors are further configured to:
transmit, to the UE, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

13. The base station of claim 12, wherein:
the first set of parameters indicates a first set of beam failure detection reference signals, a first set of new beam identification reference signals, and a first set of default power control parameters; and
the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

14. The base station of claim 10, wherein the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

15. The base station of claim 14, wherein:
the downlink channel reception occasion is a first actual transmitted downlink channel repetition or a last actual transmitted downlink channel repetition;
the downlink channel reception occasion is a first configured downlink channel repetition or a last configured downlink channel repetition; or
the downlink channel reception occasion is a first scheduled downlink channel repetition or a last scheduled downlink channel repetition.

16. A method of wireless communication performed by a user equipment (UE), comprising:
transmitting, to a base station, a beam failure recovery request based at least in part on a beam failure between a transmit-receive point (TRP) of the base station and a panel of the UE;
receiving, from the base station, a beam failure recovery response based at least in part on the beam failure recovery request; and
performing, to the base station, an uplink channel transmission based at least in part on per-TRP-and-panel power control parameters that are associated with the TRP and the panel.

17. The method of claim 16, further comprising:
determining the per-TRP-and-panel power control parameters, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

18. The method of claim 16, wherein the beam failure recovery request is associated with a per-TRP beam failure recovery, wherein the per-TRP beam failure recovery includes a per-TRP beam failure recovery in a primary cell or a per-TRP beam failure recovery in a secondary cell configured with a physical uplink control channel.

19. The method of claim 16, further comprising:
receiving, from the base station, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

20. The method of claim 19, wherein:
the first set of parameters indicates a first set of beam failure detection reference signals, a first set of new beam identification reference signals, and a first set of default power control parameters; and
the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

21. The method of claim 16, wherein the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

22. The method of claim 21, wherein the downlink channel reception occasion is a first actual transmitted downlink channel repetition or a last actual transmitted downlink channel repetition.

23. The method of claim 21, wherein the downlink channel reception occasion is a first configured downlink channel repetition or a last configured downlink channel repetition.

24. The method of claim 21, wherein the downlink channel reception occasion is a first scheduled downlink channel repetition or a last scheduled downlink channel repetition.

25. A method of wireless communication performed by a base station, comprising:
receiving, from a user equipment (UE), a beam failure recovery request based at least in part on a beam failure between a transmit-receive point (TRP) of the base station and a panel of the UE;
transmitting, to the UE, a beam failure recovery response based at least in part on the beam failure recovery request; and
receiving, from the UE, an uplink channel transmission based at least in part on per-TRP-and-panel power control parameters that are associated with the TRP and the panel.

26. The method of claim 25, wherein the per-TRP-and-panel power control parameters include a first power control parameter and a second power control parameter, wherein the first power control parameter indicates a nominal power level with an identifier associated with the TRP and the panel, and wherein the second power control parameter indicates a closed loop index with an identifier associated with the TRP and the panel.

27. The method of claim 25, further comprising:
transmitting, to the UE, a configuration that indicates the per-TRP-and-panel power control parameters, wherein the configuration indicates a first set of parameters associated with a first TRP of the base station and a first panel of the UE and indicates a second set of parameters associated with a second TRP of the base station and a second panel of the UE, and wherein the beam failure between the TRP and the panel is between either the first TRP and the first panel or between the second TRP and the second panel.

28. The method of claim 27, wherein:
the first set of parameters indicates a first set of beam failure detection reference signals, a first set of new beam identification reference signals, and a first set of default power control parameters; and
the second set of parameters indicates a second set of beam failure detection reference signals, a second set of new beam identification reference signals, and a second set of default power control parameters, wherein the first set of default power control parameters or the second set of default power control parameters corresponds to the per-TRP-and-panel power control parameters.

29. The method of claim 25, wherein the beam failure recovery response is associated with a plurality of downlink channel reception occasions and downlink channel repetitions are enabled, wherein a downlink channel reception occasion of the plurality of downlink channel reception occasions starts a symbol count, wherein the symbol count is associated with a quantity of symbols that separate the beam failure recovery response and a reset to a new beam for the uplink channel transmission.

30. The method of claim 29, wherein:
the downlink channel reception occasion is a first actual transmitted downlink channel repetition or a last actual transmitted downlink channel repetition;
the downlink channel reception occasion is a first configured downlink channel repetition or a last configured downlink channel repetition; or
the downlink channel reception occasion is a first scheduled downlink channel repetition or a last scheduled downlink channel repetition.
